(19) United States
(12) Patent Application Publication
(10) Pub. No.: US 2013/0000668 A1
(43) Pub. Date: Jan. 3, 2013

(54) DENTAL INTERPROXIMAL CLEANING DEVICE

(75) Inventor: Niels Madsen, Lyngby (DK)

(73) Assignee: NIELS MADSEN HOLDING APS

(21) Appl. No.: 13/511,784

(22) PCT Filed: Nov. 24, 2010
(86) PCT No.: PCT/EP2010/068130

§ 371 Date: May 24, 2012

(30) Foreign Application Priority Data
Nov. 24, 2009 (EP) 09176918.2

(51) Int. Cl. A61C 15/04

(52) U.S. Cl. 132/323

(57) ABSTRACT

By the invention a dental interproximal cleaning device is provided including a handle and a holder, the handle having a proximal end and a distal end, the holder having a base joined to the distal end and a bifurcation forming two branches and a cleaning element extending between the branches of the bifurcation. The cleaning element has a thread element and a brush element, the thread element having a length corresponding at least to the transversal dimension of a tooth or to the transversal dimension of a contact surface between said tooth and an adjacent tooth, and the brush element having a length at least corresponding to one half of the length of the thread element.

### CROSS-REFERENCE TO RELATED APPLICATION

This application is a national phase filing, under 35 U.S.C. §371(c), of International Application No. PCT/EP2010/068130, filed Nov. 24, 2010, the disclosure of which is incorporated herein by reference in its entirety.

### FEDERALLY SPONSORED RESEARCH OR DEVELOPMENT

Not Applicable

### BACKGROUND

To maintain a good personal dental hygiene, known prior art devices, such as toothbrushes, dental floss and interproximal brushes, may be used, preferably supplemented by regular professional cleaning which typically involves professional removal of dental plaque, both hard and soft, from the surface of the tooth by machine polishing, ultrasound etc., and by hand instruments. Despite the wide availability of devices for cleaning the teeth and the availability of professional cleaning, many people still suffer from caries, gingivitis and other diseases caused by bad dental hygiene. The result of not removing the dental plaque, which is a biofilm on the teeth containing bacteria, and any food debris, which may serve as nutrition for the bacteria, may be caries, gingivitis or other diseases caused by bad dental hygiene. Especially the interproximal spaces, which in the context of the present invention is to include both the space between two adjacent teeth and the interproximal surfaces, i.e. the adjacent (mesial and distal) surfaces of two adjacent teeth, are prone to suffer from inadequate cleaning when only a toothbrush is used since the bristles of the toothbrush do not reach into the interproximal spaces to remove food debris from the interproximal spaces and clean the interproximal surfaces. Thus separate cleaning of the interproximal spaces of the teeth is necessary to maintain a good dental hygiene and prevent caries, gingivitis and other dental related diseases.

Common devices for cleaning the interproximal spaces of the teeth include dental floss, toothpicks and interproximal brushes. Dental floss comprises a length of thread which is passed between the teeth to clean the interproximal spaces while being held by the user so that one end of the dental floss is held in one hand or wrapped around a finger of one hand, the other end being held by the other hand or being wrapped around a finger of the other hand. Although somewhat effective in removing plaque from the teeth, dental floss has numerous drawbacks, such as the tendency to cut into the hands or fingers of the user during use, the inability to reach concave surfaces of the teeth, the risk of cutting into the gums, the need for several different diameters to fit varying interproximal distances, the need for the user to put his fingers into his mouth and the risk of the floss breaking and becoming stuck between the teeth, which causes flossing with dental floss to be difficult, unpleasant and unattractive for many persons. Floss wands or floss picks, i.e. where a handle carries a piece of floss strung between two prongs, have mitigated some of the disadvantages mentioned above, but still the dental floss cannot provide cleaning of all the surfaces of the interproximal spaces of the teeth.

Toothpicks on the other hand, while being simple and non-expensive are mainly used from the buccal, i.e. the cheek, side of the mouth, and can thus only with great difficulty be inserted from the lingual. i.e. from the tongue, side of the tooth. Thus only partial cleaning of the interproximal spaces of the teeth is achieved with the toothpick. Further, as toothpicks require a certain amount of rigidity to be usable, they cannot be made sufficiently thin for effective use in the interproximal spaces, further a risk of stabbing the gum exists, causing pain and bleeding, which is very unattractive to the user of the toothpick.

On the other hand, a very good cleaning of the interproximal spaces of the teeth is provided by the use of interproximal brushes. These are typically miniature brushes comprising a rigid elongated spine of two or more metallic wires twisted around each other to hold numerous fine nylon bristles between them, the brush being grasped by a small handle in which the spine is attached, and inserted into an interproximal space between two adjacent teeth for removing plaque and food debris. Despite being highly effective in reaching all surfaces of the interproximal spaces of the teeth, the use of interproximal brushes is limited due to a number of serious limitations. To be able to be inserted between the teeth, the spine has to be rigid, which causes a significant risk of the user of stabbing the gum, or damaging the teeth, with the point, i.e. the end, of the spine. Further, the spine, while requiring a certain thickness to have the necessary rigidity, must also be sufficiently thin to fit in the interproximal spaces of the teeth. There is thus a risk of the spine either bending or breaking during use, or having a diameter that is too large to fit in an interproximal space between two teeth. Further, the use of metallic wire to form the spine may result in an unpleasant feeling for the user, and may further damage the teeth due to lever action if the user holding the interproximal brush is disturbed or startled during cleaning. To further complicate the use of interproximal brushes, they are difficult to use on the back teeth as the handle and the reduced space at the back of the mouth make their insertion difficult and prone to complications as described above.

Attempts to combine the above mentioned devices to achieve an improved cleaning of the interproximal spaces of the teeth are described in amongst others EP1190683, U.S. Pat. No. 6,250,313, U.S. Pat. No. 5,063,948, U.S. Pat. No. 6,672,316 and U.S. Pat. No. 4,008,727. The reference JP200424371 further includes a holder.

The above-cited documents describe combinations of dental floss with either brushes or enlarged portions of the dental floss. Although an increased cleaning efficiency of the interproximal spaces of the teeth may be achieved, the user still has to grasp the dental floss with his hands resulting in the dental floss cutting into the hands and difficulty in reaching the back teeth. In addition, the holder of JP200424371 is highly complex and thus expensive to manufacture.

A combination of a holder and an interdental brush is shown in U.S. Pat. No. 5,125,424, however, as the interproximal space between two adjacent teeth is typically larger near the gum line compared to at the top of the crown, the device may only be used where the distance between the teeth allows the brush to be passed there between, in which case the distance between the teeth is so large that the use of an interdental brush is often not needed.

A holder holding dental floss, a portion of which is fuzzy is shown in DE8708369U, however, the cleaning efficiency of the fuzzy portion of the dental floss is limited.

Holders for dental floss further including brushes attached to the holder for brushing the buccal and lingual sides of teeth as shown in inter alia US2006054180 and U.S. Pat. No. 5,331,983, thus no, or only limited cleaning of the interproximal spaces is achieved.

Lastly, a holder with a length of dental floss, the dental floss including a centered brush portion, is shown in DE29509846U, however, the device is at an disadvantage in the back of the mouth where its width which, due to the two lengths of dental floss, each required to be at least as long as the width of the teeth to be cleaned, restricts it to being inserted from one side only.

### SUMMARY

It is an object of the present invention to simplify the cleaning of interproximal spaces of teeth.

It is a further object of the present invention to increase the efficiency of cleaning the interproximal spaces of teeth.

It is a further object of the present invention to make the cleaning of interproximal spaces of teeth more convenient.

It is a further object of the present invention to increase the safety for a user cleaning the interproximal spaces of his teeth.

It is a further object of the present invention to provide a device for achieving at least the above-mentioned objects.

The above objects, together with numerous other objects, which will be evident from the below detailed description of preferred embodiments of the dental interproximal cleaning device according to the present invention, are according to a first aspect of the present invention obtained by a dental interproximal cleaning device including a handle and a holder
i) the handle having a proximal end and a distal end,
ii) the holder having a base joined to the distal end and a bifurcation forming two branches and a cleaning element extending between the branches of the bifurcation,
the cleaning element including two brush elements, one of which is provided on a first side of the thread element, and the other being provided on a second side of the thread element, and optionally, one of the brush elements having a first maximum diameter and the other of the brush elements having a second maximum diameter smaller than the first maximum diameter, and preferably, the brush elements having a diameter which varies along the longitudinal dimension of the cleaning element, and
the thread element having a length corresponding at least to the transverse dimension of a tooth or to the transverse dimension of a contact surface between the tooth and an adjacent tooth, and the brush element having a length at least corresponding to one half of the length of the thread element.

The handle may comprise a grip part positioned between the proximal end and the distal end, alternatively the grip part may extend from the proximal end to the distal end. The grip part may be adapted to be grasped by a hand or individual fingers. The handle is typically made from plastic through moulding and may be covered with rubber or similar friction enhancing materials to provide a sure grip for the user. The surface of the handle may further be moulded with a roughened surface or a surface comprising ridges or the like to ensure a sure grip. The handle may further be sculpted to provide contact areas for the individual fingers, i.e. the thumb, index finger etc, of the user's hand to create a handle, which is also comfortable to use.

The transverse dimension of a tooth typically corresponds to a length of about 8 mm such as for the average molar, a length in the range of 5 to 6 mm such as for premolars/canines and a length in the range of 1 to 3 mm for incisors, however, due to natural variation, the transverse length of a tooth could be in the range of 1 to 15 mm. When the thread element has a length corresponding at least to the transverse dimension of a tooth a cleaning element usable for varying interproximal spaces is achieved. The transverse dimension of a contact surface between the tooth and an adjacent tooth is typically about one half or two thirds of the transverse dimension of a tooth. When the thread element has a length corresponding to at least the transverse dimension of a contact surface between the tooth and an adjacent tooth, a shorter cleaning element is achieved which, may be advantageous as it enables a narrower holder.

The length of the thread element could be at least about 0.5 mm, but preferably the thread element has a length suitable for use for all interproximal spaces of the teeth. A thread cleaning element for use both in interproximal spaces of molars as well as interproximal spaces of incisors could be at least 8 mm such as 8-30 mm or more preferably 8-20 mm. The transverse dimension of a tooth may be used for dimensioning the length of the thread element if there is no contact, and thus no contact surface, between the tooth and an adjacent tooth.

According to the dental interproximal cleaning device according to the first aspect of the present invention, the cleaning element includes two brush elements, one of which is provided on a first side of the thread element, and the other being provided on a second side of the thread element, and optionally, one of the brush elements having a first maximum diameter and the other of the brush elements having a second maximum diameter smaller than the first maximum diameter, and preferably, the brush elements having a diameter which varies along the longitudinal dimension of the cleaning element. An advantage of a cleaning element having two brush elements is that the dental interproximal cleaning device is easy to use both for a right-handed and a left-handed user and further is easy to position in the mouth as the thread element is provided close to the middle of the holder, which also simplifies the passing of the thread element between adjacent teeth. To increase the versatility of the dental interproximal cleaning device according to the first aspect of the present invention brush elements having differing maximum diameters may be used as this yields the advantage that a user may clean interproximal spaces of varying dimensions without needing to change holder or cleaning element. By using brush elements having a diameter that varies along the longitudinal dimension of the cleaning element, interproximal spaces having a wide variety of dimensions may be cleaned with one cleaning element.

The distance between the branches of the holder should correspond to the length of the cleaning element, however, the holder should fit within the mouth of the user, and thus the holder may vary further in size depending on the user, who may be a child, a woman or a man. A typical distance between the branches of the holder may be about 30 mm, such as from 20 mm to 40 mm, but shorter or longer distances are possible as long as the distance corresponds to the length of the cleaning element and the holder fits in the mouth of the user.

The diameter of the thread element should allow the thread element to be passed between adjacent teeth.

The brush element should have a maximum diameter in the range of 1 to 10 mm such as 2-6 mm, and further said diameter should depend on the size of the interproximal space to be cleaned.

The handle should fit the hand or fingers of the hand of the user which may be a child, a woman or a man. Thus the handle may have a variety of dimensions provided that the handle is usable for the user. The size of the handle may for example also vary depending on whether the holder is permanently joined to the handle, in which case the handle may be smaller and for example be gripped by the fingers of one hand, or releasably joined to the handle, in which case a larger handle is typically used for comfort.

In embodiments of the dental interproximal cleaning device according to the first aspect of the present invention the holder may be permanently joined to the handle, or alternatively, the holder may be releasably joined to the handle. A holder permanently joined to the handle may be advantageous for example where the dental interproximal cleaning device according to the present invention is supplied sterilized for professional dental use such as for a dental surgery and any reuse of any part, including the handle, is undesired. Further, the dental interproximal cleaning device may be manufactured at a lower cost when the holder is permanently joined to the handle, which may be advantageous for use by users requiring only infrequent cleaning of interproximal spaces of their teeth. It is, however, preferred that the holder is releasably joined to the handle since it is more economical and environment friendly to exchange only the holder with the cleaning element for frequent users requiring frequent use of the dental interproximal cleaning device according to the present invention. Further, the handle and the holder may be made of different materials including a stainless steel handle and a plastic holder, which may allow the handle to be easily sterilized between uses. Further, holders bearing different types of cleaning elements may be used with a single handle to efficiently clean different interproximal spaces. In particular, holders bearing cleaning elements having thread elements of different lengths to fit transverse dimensions of different teeth, such as molars, premolars/canines and incisors, may be used. It is further contemplated within the context of the present invention that the cleaning element could be releasably attached to the holder, so that the cleaning element could be supplied in bulk form such as on a spool, and a suitable length for extending between the branches of the holder could be cut off and fastened to the branches for example by threading the ends of the cleaning element though channels in the branches or by winding the ends of the cleaning element around the branches or pegs provided on the branches. This could be advantageous for dental professionals treating numerous patients as it would be more cost efficient to exchange only the cleaning element. As an alternative to cutting the cleaning element from a continuous length supplied on a spool, single cleaning elements may be provided and be equipped with rings, knots or small beads at the ends for attaching to pegs or for retention by passing through a channel or a notch in the branches having a smaller diameter than the beads or rings, thus making it possible to exchange only the cleaning element. The ends of the cleaning element may also be attached to the branches of the holder through adhesives, by melting and solidifying part of the branches, or by being moulded into the branches, the above methods optionally including rings, knots or small beads on the ends of the cleaning element to increase the strength of the cleaning element/holder joint. When the cleaning element is supplied on a spool, this spool may be located in a depot in the handle from where it may be dispensed and attached to the branches, optionally as a continuous cleaning element where the used cleaning element may be cut off and disposed of or led to another spool in the handle for later disposal.

A further advantage to the holder being releasably joined to the handle is that the holder may be released from the handle and be grasped by the user directly and used.

It is further contemplated within the context of the present invention that the handle could include a toothbrush part, including a head holding bristles, at its proximal end so that the user can brush his teeth with the toothbrush part and clean the interproximal spaces of his teeth with the same dental interproximal cleaning device according to the present invention.

In a preferred embodiment of the dental interproximal cleaning device according to the first aspect of the present invention, the brush elements are conical or frustoconical and have their smallest diameters closest to the thread element.

In a more preferred embodiment of the dental interproximal cleaning device according to the first aspect of the present invention, the brush elements have conical or frustoconical portions and have their smallest diameters closest to the thread element. In this case another portion of the brush element may be for example cylindrical or have a diameter varying along the brush element. This is advantageous as it allows the brush elements to be advanced into the interproximal space to the depth possible and no more.

It is further contemplated within the context of the present invention that the brush elements may have different properties, such as having bristles of different materials and rigidity, having different construction, or having different coatings, for example a polishing coating on one brush element and a fluoride coating on the other brush element.

In a preferred embodiment of the dental interproximal cleaning device according to the first aspect of the present invention, the thread element has a length substantially corresponding to the transverse dimension of a tooth or to the transverse dimension of a contact surface between the tooth and an adjacent tooth, and each brush element has a length substantially corresponding to one half of the length of the thread element.

This is advantageous as it provides a cleaning element having a length of substantially two times the transverse dimension of a tooth or to the transverse dimension of a contact surface between the tooth and an adjacent tooth, thereby providing a cleaning element of minimum width for cleaning the interproximal spaces in the back of the mouth, which are especially hard to clean since teeth in the back of the mouth are hard to reach and the space around the teeth is limited due to the temporomandibular joints, i.e. the joints of the jaw, and the large width of the teeth in the back of the mouth

In a further embodiment of the dental interproximal cleaning device according to the first aspect of the present invention, the handle has at the distal end a groove for receiving a portion of the base and a retaining element for engaging an indentation in the base. By the use of a groove and a retaining element the holder may be securely and releasably joined to the handle. The retaining element is preferably operable by the user of the dental interproximal cleaning device to selectively release the holder. Further methods of releasably joining the holder to the handle include a snap-fit connection, an interference fit connection, a screw, a magnet, a hook and loop connection, a shaft and corresponding aperture in the holder, or a squeezable buckle etc.

In a further embodiment of the dental interproximal cleaning device according to the first aspect of the present invention, the holder is integral with the cleaning element, preferably through moulding of the holder and the cleaning element. The holder and the cleaning element may advantageously be integral, such as by moulding whereby a single-piece holder/cleaning element is obtained which does not include any complicated assembly of individual parts and can be manufactured in high volume at low cost. Thus the holder and the cleaning element may be moulded from a single, preferably plastic, material such as polypropylene, polyethylene terephthalate, polyamide, polyethylene, polytetrafluoroethylene, polyetheretherketone etc.

In embodiments of the dental interproximal cleaning device according to the first aspect of the present invention, there may be tension in the cleaning element as it extends between the branches of the holder, or alternatively the cleaning element may extend slackly between the branches of the holder. Tension in the cleaning element may result in a greater strength and effectiveness of the brush elements described in embodiments below while less tension or no tension in the cleaning element allows the thread element to more closely conform to the interproximal surfaces.

In a further embodiment of the dental interproximal cleaning device according to the first aspect of the present invention, the cleaning element includes two strands twisted around each other and bristles inserted between the strands along a portion of the strands to form the brush element, the remainder of the strands forming the thread element. This is advantageous as it allows a simple construction of the cleaning element, further, by using strands the diameter of the spine of the brush element. i.e. the twisted strands fixating the bristles of the brush element, approximates that of the diameter of the thread element, i.e. the twisted strands without bristles, and the resulting cleaning element with brush element may be used also in interproximal spaces of smaller dimensions when compared with a brush having a spine of twisted wires. Further, as the strands may be flexible, the resulting cleaning element including the brush element(s) may be somewhat flexible, thus being easier to pass between adjacent teeth and being more comfortable to use. If more than two strands are used they may be braided instead of twisted analogously to the above. The strands may be made out of a bundle of nylon fibres or a monofilament nylon or Teflon or polyethylene. The cleaning element is preferably tensioned between the branches of the holder to prevent further twisting or bunching up of the twisted strands and to aid fixation of the bristles between the strands.

In alternative embodiments of the dental interproximal cleaning device according to the first aspect of the present invention, the cleaning element includes a thread and a wire twisted around a portion of the thread to fixate bristles to the thread to form the brush element, the remainder of the thread forming the thread element, or alternatively the cleaning element includes a thread and bristles affixed by knots, glue or welding to the thread along a portion of the thread to form, the brush element, the remainder of the thread forming the thread element. By using a twisted wire to fixate the bristles to the thread, a stiffening of the brush element may be achieved, which may be advantageous for increasing the intensity of brushing in larger interproximal spaces. By fastening the bristles using a wire, knots, glue or welding, stronger monofilament threads such as nylon line or less flexible fibres such as glass fibre or aramid fibres such as Kevlar (registered trademark) fibres, which are not easily twisted or braided, may be used. The wire may be a plastic wire which may additionally be melt bonded to the thread, or may be a metal wire. The cleaning element may be tensioned, but may also have little or no tension as the twisted wire stiffens the brush element, and the knots, glue or welding alternatively used to fixate the bristles to the thread may achieve a sufficient fixation of the bristles also when the cleaning element has little or no tension. Further the thread may be a wire of steel to which the bristles, typically being made of plastic or nylon, are welded to form a brush element.

In a further embodiment of the dental interproximal cleaning device according to the first aspect of the present invention, the thread element may include a thread and the brush element may include two wires twisted around each other to fixate bristles between the wires, one end of the thread element being joined to one end of the brush element. Thus the cleaning element may be provided from two separate parts which are joined, the advantage being a wider choice of materials available for the thread element and the brush element. The cleaning element may be tensioned or not, however, by tensioning the cleaning element, the diameter of the wires may be reduced as the brush element achieves a higher rigidity and resistance to breakage through bending by the tensioning of the cleaning element. The wires may be plastic wires or metal wires.

In an advantageous embodiment of the dental interproximal cleaning device according to the first aspect of the present invention, the cleaning element may include a thread having protrusions along a portion of the thread to form the brush element, the remainder of the thread forming the thread element, the advantage being the possibility of forming the cleaning element in a single step and from a single raw material. The cleaning element may be moulded to include the protrusions, or alternatively the protrusions may be extruded from the thread. The protrusions may form bristles or may alternatively be in the form of thorns or hooks for cleaning the interproximal surfaces. The protrusions may be extruded from the thread by heating the thread in a mould and applying suction through a plurality of channels to force part of the thread material to flow into the channels, thus forming the protrusions. A further advantage is that the cleaning element may be integrally moulded with a holder as described above. The cleaning element may be tensioned or not.

In another embodiment of the dental interproximal cleaning device according to the first aspect of the present invention, the cleaning element may include a thread having a moulded jacket along a portion of the thread to form the brush element, and the remainder of the thread forming the thread element. The advantage is that the brush element may be used for polishing the surfaces of the interproximal spaces of the teeth. The jacket may typically be made of rubber or plastic, and may further include a polishing agent or an abrasive agent such as pumice. The holder and cleaning element may also be manufactured in a two step moulding process where in a first step a holder is moulded integrally with a thread, and in a second step the jacket is moulded onto portions of the thread to form the cleaning element.

In another embodiment of the dental interproximal cleaning device according to the first aspect of the present invention, the cleaning element may include a thread having a moulded jacket along a portion of the thread to form the brush element, the jacket further having protrusions, and the remainder of the thread forming the thread element. The advantage is that the brush element may be cheaply and simply moulded while any thread, for example a non-mouldable thread of increased strength, may be used for the thread element. The jacket may typically be made of rubber or plastic. The holder and cleaning element may also be manufactured in a two-step moulding process where in a first step a holder is moulded integrally with a thread, and in a second step the jacket is moulded onto portions of the thread to form the cleaning element.

In another embodiment of the dental interproximal cleaning device according to the first aspect of the present invention, the cleaning element may include a thread having a plurality of stacked discs moulded around it along a portion of the thread to form the brush element. The discs may be connected to each other or may be separate from each other. Typically the discs are made of rubber or plastic. The advantage is that the brush element may be cheaply and simply moulded while any thread, for example a non-mouldable thread of increased strength, may be used for the thread element.

Generally, suitable materials for the handle and holder includes metals such as stainless steel, aluminum, titanium and plastic such as polypropylene, polyethylene terephthalate, polyamide, polyethylene, polytetrafluoroethylene, polyetheretherketone etc, possible reinforced with glass fibre or carbon fibre. Suitable materials for the cleaning element include the plastics above as well as fibres of aramid (Kevlar), glass and carbon. When the cleaning element includes bristles, these bristles typically include polyamide, the bristles optionally including microfibres or nanofibres. When the cleaning element includes moulded brush elements, these brush elements may be made of rubber or the plastics above. When the cleaning element includes a wire, the wire may be a plastic wire or a metal wire.

In another embodiment of the dental interproximal cleaning device according to the first aspect of the present invention the handle may further include:
a battery for storing electrical energy,
an electric motor having an output shaft,
a coupler at the distal end of the handle, the coupler converting kinetic energy from the output shaft of the motor to motion of the cleaning element, and
a switch connected to the battery and the motor and being operable to selectively energise the motor, wherein the motion is selected from the group including reciprocal linear motion along the longitudinal dimension of the cleaning element, mono-directional linear motion along the longitudinal dimension of the cleaning element, transverse motion, rotational motion around the longitudinal dimension of the cleaning element, tilting motion, or combinations thereof.

By providing a motor to cause motion of the cleaning element, the cleaning effectiveness of the dental interproximal cleaning device according to the first aspect of the present invention may be enhanced and the time needed to clean an interproximal space between two adjacent teeth may be shortened. The battery is preferably a rechargeable battery such as a nickel metal hydride battery or a lithium ion battery. The motor may be a dc motor but may also be a piezoelectric motor. The coupler may include a wheel with a peg connected to a pushrod for converting a rotational motion from the output shaft of the motor to a reciprocal motion of the cleaning element, typically by moving the holder. Alternatively the coupler may include a wheel and the cleaning element may form a closed loop allowing the cleaning element to move in a single direction in tubes in the branches of the holder in a path defined by the wheel of the coupler and the tubes. A further alternative is where the coupler converts rotational motion from the output shaft of the motor to vibrations to increase the cleaning efficiency of the bristles of the cleaning element.

By combining different motions, an increased cleaning efficiency may be achieved. For example rotational motion around the longitudinal dimension of the cleaning element for achieving an intense loosening of dental plaque or food debris in the interproximal space may be combined with a reciprocal linear motion along the longitudinal dimension of the cleaning element for efficiently removing the loosened dental plaque or food debris from the interproximal space.

In addition, or as an alternative, to placing the motor and coupler in the handle, rotational motion around the longitudinal dimension of the cleaning element may also be achieved by placing the motor and coupler at the end of one of the branches of the holder so that one end of the cleaning element is coupled to the coupler at the end of one branch, and the other end of the cleaning element is rotatably connected to the end of the other branch.

In addition to cleaning interproximal spaces of the teeth, the dental interproximal cleaning device according to the first aspect of the present invention may be used professionally by a dentist or dental hygienist to apply prophylactic treatments to the surfaces of interproximal spaces of the teeth of a patient by infusing or applying to the cleaning element a suitable agent, such as fluoride lacquer, and thereafter treating the interproximal spaces. Other suitable agents include toothpaste, polishing agents and disinfecting agents. The thread element of the cleaning element may comprise a metal wire or a Kevlar wire, and the cleaning element may be autoclavable if reusable. Further the brush element may comprise a rubber cylinder moulded onto or threaded onto a portion of the thread of the thread element. The rubber cylinder may include or be coated with a suitable agent as described above.

An advantage of the dental interproximal cleaning device according to the first aspect of the present invention is that it achieves the efficiency of the previously difficult to use interproximal brush and is easily positioned and cleans the interproximal spaces of the teeth without any risk of injury to the teeth or gums. Further, by providing tension in the cleaning element, a brush element may be more easily and securely used in interproximal spaces.

A further advantage of the dental interproximal cleaning device according to the first aspect of the present invention is that it achieves a more efficient cleaning of the interproximal spaces of the teeth, also in the back of the mouth.

A further advantage of the dental interproximal cleaning device according to the first aspect of the present invention is that the user may feel his way by using only the dental floss. i.e. using only the thread element of the cleaning element, at first, and then where possible, subsequently advance the brush element or elements into any sufficiently large interproximal spaces in need of cleaning in one movement.

Another advantage of the dental interproximal cleaning device according to the first aspect of the present invention is that it is convenient to use requiring only one hand for operation.

In a second aspect of the present invention a holder of the dental interproximal cleaning device according the first aspect of the present invention is provided.

The holder may further be adapted to be used with conventional reciprocating electric toothbrushes.

In a third aspect of the present invention a cleaning element of the dental interproximal cleaning device according to the first aspect of the present invention is provided.

In a fourth aspect of the present invention a method of cleaning an interproximal space of adjacent teeth is provided comprising the steps of:
providing a dental interproximal cleaning device according to the first aspect of the present invention.
inserting the thread element into the interproximal space, and
moving the cleaning element so as to cause the brush element to enter, and thereby clean, the interproximal space.

The method according to the fourth aspect of the present invention provides efficient cleaning of an interproximal space of adjacent teeth without the risk of injury to the gums.

The invention and its many advantages will be described in more detail below with reference to the accompanying schematic drawings, which for the purpose of illustration show some non-limiting embodiments and in which

### BRIEF DESCRIPTION OF THE DRAWINGS

FIGS. 1A-1C show a dental interproximal cleaning device comprising a handle with attached holder together with further detached holders according to an embodiment of the present invention.

FIGS. 2A-2C show different embodiments of the cleaning element according to the present invention.

FIGS. 3A-3F show different embodiments of the construction of the cleaning element according to the present invention.

### DETAILED DESCRIPTION

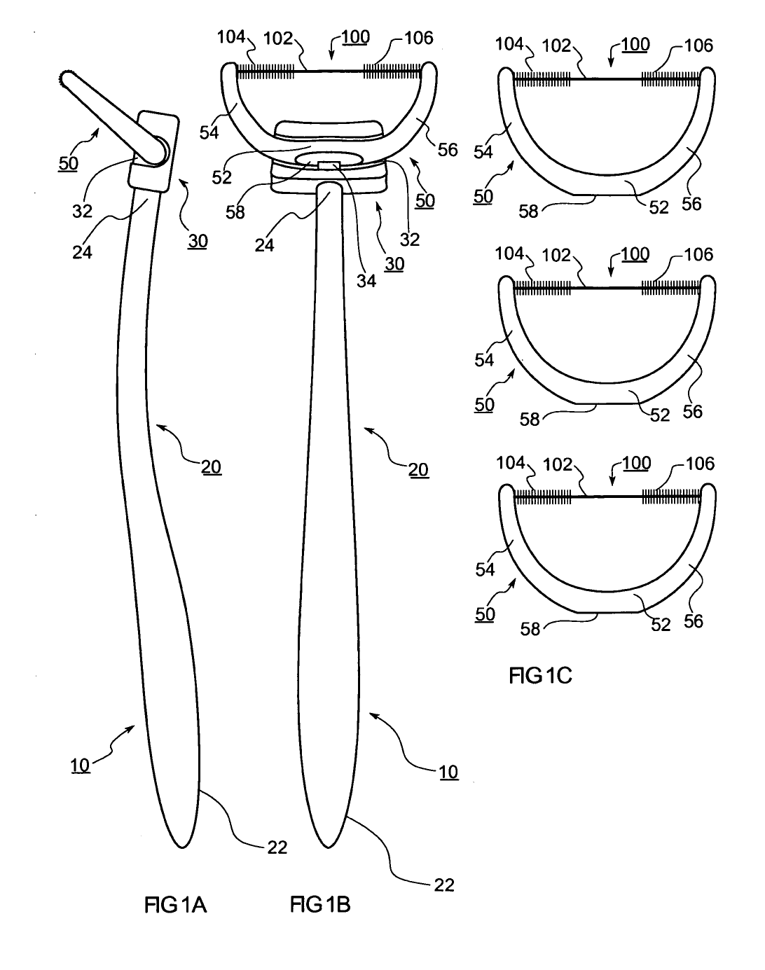

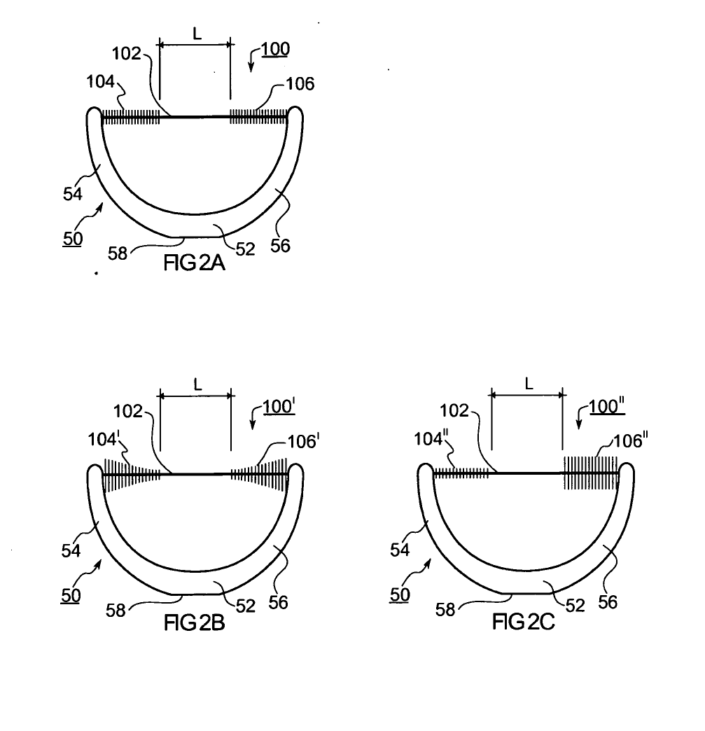

FIG. 1A shows a side view of a dental interproximal cleaning device, in its whole designated the reference numeral 10, according to one embodiment of the present invention. The dental interproximal cleaning device includes a handle, in its whole designated the reference numeral 20, a holder, in its whole designated the reference numeral 50 and a cleaning element, in its whole designated the reference numeral 100. The handle 20 is shaped to be easily grasped by the hand or a plurality of individual fingers of a user and has a first end, designated the reference numeral 22 and a second end, designated the reference numeral 24, joined to a head part, in its whole designated the reference numeral 30. The head part 30 has a groove, designated the reference numeral 32, for interengagement with the holder 50, and a retaining element, designated the reference numeral 34, which is shown in FIG. 1B which shows a plan view of the dental interproximal cleaning device 10. The holder 50 includes a base, designated the reference numeral 52, and has an indentation, designated the reference numeral 58 in the base 52 for interengagement with the retaining element 34 in the head 30. The holder 50 further includes a bifurcation forming first and second branches, designated the reference numerals 54 and 56 respectively, which support the cleaning element 100. The cleaning element 100 includes a thread element, designated the reference numeral 102, and first and second brush elements, designated the reference numeral 104 and 106 respectively, the ends of the cleaning element 100 being attached to the first and second branches 54 and 56 by for example moulding or adhesives. Due to the grove 32, the retaining element 34, and the indentation 58 in the base 52 of the holder 50, the holder 50 may be attached or detached from the head part 30 as desired, such as for replacing the holder 50, when the cleaning element 100 has worn out and is no longer effective, with a replacement holder, such as shown in FIG. 1C where three holders are shown, or alternatively for replacing the holder 50 with a holder bearing a different kind of cleaning element as will be described in FIG. 2 below. The retaining element 34 may be biased to engage the indentation 58 by a spring in the handle 20, or may alternatively be static where instead the material of the head part 30 flexes resiliently as the base 52 of the holder 50 is inserted into the groove 32.

FIG. 2 shows different embodiments of the cleaning element according to the present invention. FIG. 2A shows the same cleaning element 100 as shown in FIG. 1. The thread element 102 has a length, designated L, which corresponds at least to the transverse dimension of a tooth or to the transverse dimension of a contact surface between said tooth and an adjacent tooth (not shown). In use the thread element 102 may be positioned between two adjacent teeth whereby cleaning of the interproximal space of the teeth is accomplished initially as the thread element 102 is passed between the teeth towards the gums and subsequently by moving the cleaning element 100 reciprocally or non-reciprocally along the longitudinal dimension of the cleaning element 100 to cause the first and second brush elements 104 and 106 to enter and exit the interproximal space repeatedly, thereby removing food debris from the interproximal space and cleaning the interproximal surfaces of the adjacent teeth.

In FIG. 2B a second embodiment of a cleaning element, designated the reference numeral 100^{I}, is shown, the difference being a first and second brush element, designated the reference numeral 104^{I} and 106^{I}, respectively, which are of varying diameter along the length of the cleaning element 100^{I}, and more particularly as shown in FIG. 2B, cone-shaped. The cleaning element 100^{I} may advantageously be used where the user of the dental interproximal cleaning device 10 has varying interproximal spaces between different pairs of his teeth.

Also the third embodiment of the cleaning element, designated the reference numeral 100^{II}, in FIG. 2C, is advantageous for cleaning interproximal spaces of varying dimensions, by virtue of first and second brush elements, designated the reference numerals 104^{II} and 106^{II}, respectively, which are of different maximum diameter.

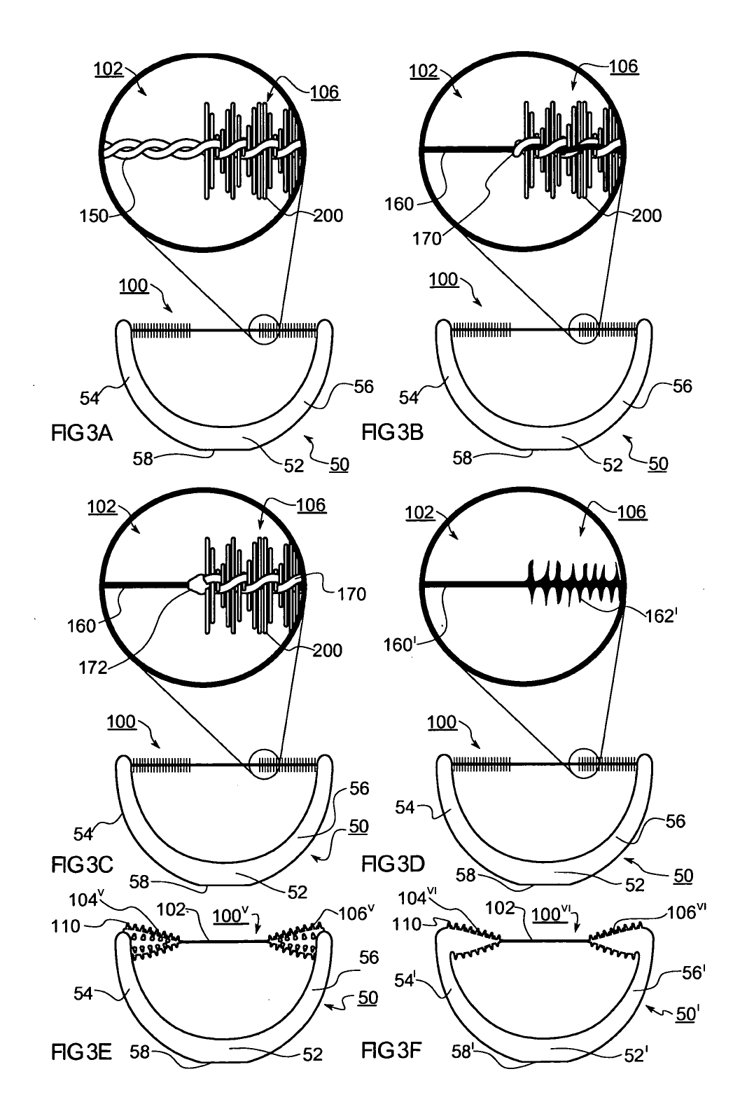

The cleaning element with brush element and thread element may be constructed as described below with reference to FIG. 3.

In FIG. 3A the cleaning element 100 is constructed using two strands, one of which is designated the reference numeral 150, which are twisted around each other to form the thread element 102. Prior to twisting of the strands 150, bristles, one of which is designated the reference numeral 200, are inserted between the strands 150 along portions of the strands corresponding to the first and second brush element, the bristles being fixated and arranged into a brush by the twisting of the strands 150. The part of the twisted strands 150 which do not include bristles thus form the thread element 102. Accordingly, the brush elements 104 and 106 are integral with the thread element.

Another construction of the cleaning element 100 is shown in FIG. 3B where two wires, one of which is designated the reference numeral 170, having bristles 200 inserted between them, are twisted around portions corresponding to the first and second brush elements 104 and 106, of a central thread, designated the reference numeral 160, to form the cleaning element including thread element 102 corresponding to the portion of the thread 160 which is not surrounded by the twisted wires 170. The thread 160 may be a single filament, but may also be a braided or twisted thread.

In FIG. 3C the brush element 106 comprises two twisted wires 170 with bristles 200 inserted between them. The wires 170 are terminated in an anchoring element, designated the reference numeral 172, to which the thread end of the thread 160 is fastened. The cleaning element 100 in FIG. 3C is thus constructed from separate first and second brush elements 104 and 106 which are joined by the thread 160 thus forming the cleaning element 100. The anchoring element 172 may a ball of solder, plastic or glue, or can alternatively be a moulded plastic or metal part having apertures for inserting the ends of the wires 170.

A further variant of constructing the cleaning element 100 is shown in FIG. 3D where an alternative thread, designated the reference number 160^{I} is used. Thread 160^{I} is preferably made from a thermoplastic material and as such may be fashioned with protrusions, one of which is designated the reference numeral 162^{I}, which are similar in function and appearance to the bristles 200 shown in FIGS. 3A-3C, but are integral with the thread 160^{I}. The thread element shown in FIG. 3D may be formed in one piece by moulding. Alternatively, the protrusions 162^{I} may be formed through extrusion from the thread 160^{I}. The protrusions 162^{I} may alternatively be moulded onto the thread 1601 when the thread 160^{I} and the protrusions 162^{I} are made from different materials, or when the thread is made from a non-thermoplastic material.

In FIG. 3E, a cleaning element, designated the reference number 100^{V} is shown where first and second brush elements, designated the reference numerals 104^{V} and 106^{V} respectively, are moulded to include protrusions, designated the reference numeral 110, and are moulded around a portion of the thread element 102, or are moulded to include a channel through which a portion of the thread element can pass, to form a cleaning element 100^{V}. Typically, the material used for the brush elements may be rubber.

Yet a possibility of constructing the a cleaning element is shown in FIG. 3F wherein a holder, designated the reference numeral 50^{I}, is moulded from a plastic material integrally with first and second brush elements, designated the reference numerals 104^{VI} and 106^{VI} respectively, including protrusions, one of which is designated the reference numeral 110, and the thread element 102 so that the thread element 102 is moulded from the same plastic material as the holder 50^{I} and the brush elements 104^{VI} and 106^{VI}, possibly including a reinforcing fibre extending between the brush elements to reinforce the thread element, resulting in a single-piece combined holder/cleaning element.

### LIST OF PARTS WITH REFERENCE TO THE FIGURES

```
  10. Dental interproximal cleaning device
  20. Handle
  22. First end
  24. Second end
  30. Head part
  32. Groove
  34. Retaining element
  50. Holder
  50^{I}. Holder (alternative embodiment)
  52. Base
  52^{I}. Base (alternative embodiment)
  54. First branch
  54^{I}. First branch (alternative embodiment)
  56. Second branch
  56^{I}. Second branch (alternative embodiment)
  58. Indentation
  58^{I}. Indentation (alternative embodiment)
100. Cleaning element
100^{I}. Cleaning element (second embodiment)
100^{II}. Cleaning element (third embodiment)
100^{V}. Cleaning element (sixth embodiment)
100^{VI}. Cleaning element (seventh embodiment)
102. Thread element
104. First brush element
104^{I}. First brush element (second embodiment)
104^{II}. First brush element (third embodiment)
104^{V}. First brush element (sixth embodiment)
104^{VI}. First brush element (seventh embodiment)
106. Second brush element
106^{I}. Second brush element (second embodiment)
106^{II}. Second embodiment (third embodiment)
106^{V}. Second brush element (sixth embodiment)
106^{VI}. Second brush element (seventh embodiment)
110. Protrusion
150. Strand
160. Thread
160^{I}. Thread (alternative embodiment)
162^{I}. Protrusion
170. Wire
172. Anchoring element
200. Bristle
```

1-13. (canceled)

14. A dental interproximal cleaning device, comprising:
a handle having a proximal end and a distal end;
a holder having a base joined to said distal end of said handle, a bifurcation forming first and second branches; and
a cleaning element extending between said first and second branches, said cleaning element including first and second brush elements, one of which is provided on a first side of a thread element, and the other being provided on a second side of said thread element;
wherein each of said brush elements comprises bristles or protrusions oriented substantially perpendicular to said thread element, each of said first and second brush elements having a conical or frustoconical portion having a smallest diameter closest to the thread element;
wherein said thread element has a length corresponding at least to the transverse dimension of a tooth or to the transverse dimension of a contact surface between said tooth and an adjacent tooth; and
wherein each of said first and second brush elements has a length at least corresponding to one half of said length of said thread element.

15. The dental interproximal cleaning device according to claim 14, wherein said holder is permanently joined to said handle

16. The dental interproximal cleaning device according to claim 14, wherein said holder is releasably joined to said handle.

17. The dental interproximal cleaning device according to claim 14, wherein said handle has, at said distal end, a groove configured to receive a portion of said base and a retaining element for engaging an indentation in said base.

18. The dental interproximal cleaning device according to claim 14, wherein said holder is integral with said cleaning element.

19. The dental interproximal cleaning device according to claim 14, wherein said cleaning element includes two strands twisted around each other and bristles inserted between said strands along a portion of said strands to form said first and second brush elements, the remainder of said strands forming said thread element.

20. The dental interproximal cleaning device according to claim 14, wherein said cleaning element includes a thread and a wire twisted around a portion of said thread to fix bristles to said thread to form said first and second brush elements, the remainder of said thread forming said thread element.

21. The dental interproximal cleaning device according to claim 14, wherein said cleaning element includes a thread and bristles affixed to said thread along a portion of said thread to form said first and second brush elements, the remainder of said thread forming said thread element.

22. The dental interproximal cleaning device according to claim 14, wherein said thread element includes a thread, and each of said first and second brush elements includes two wires twisted around each other to fix a plurality of bristles between said wires, said thread element having first and second ends, each of said first and second ends being joined to an end of one of said first and second brush elements.

23. The dental interproximal cleaning device according to claim 14, wherein said cleaning element includes a thread having protrusions along a portion of said thread to form said first and second brush elements, the remainder of said thread forming said thread element.

24. The dental interproximal cleaning device according to claim 23, wherein said cleaning element is moulded to include said protrusions.

25. The dental interproximal cleaning device according to claim 23, wherein said protrusions are extruded from said thread.

26. The dental interproximal cleaning device according to claim 14, wherein said cleaning element includes a thread having a moulded jacket along a portion of said thread to form said first and second brush elements, said jacket further having protrusions, and the remainder of said thread forming said thread element.

27. The dental interproximal cleaning device according to claim 15, wherein said handle further comprises:
a battery for storing electrical energy;
an electric motor having an output shaft;
a coupler at said distal end of said handle, said coupler being operable to convert kinetic energy from said output shaft of said motor to motion of said cleaning element; and
a switch connected to said battery and said motor and operable to selectively energize said motor, wherein said motion is selected from the group consisting of reciprocal linear motion along a longitudinal dimension of said cleaning element, mono-directional linear motion along the longitudinal dimension of said cleaning element, transverse motion, rotational motion around the longitudinal dimension of said cleaning element, tilting motion, and combinations thereof.

28. The dental interproximal cleaning device according to claim 14, wherein one of said first and second brush elements has a first maximum diameter and the other of said first and second brush elements has a second maximum diameter smaller than said first maximum diameter.

29. The dental interproximal cleaning device according to claim 14, wherein said cleaning element has a longitudinal dimension, and wherein each of said first and second brush elements has a diameter that varies along the longitudinal dimension of said cleaning element.

30. A dental interproximal cleaning element assembly, comprising:
a cleaning element holder having a bifurcation forming first and second branches; and
a cleaning element extending between said first and second branches, said cleaning element comprising a thread element having first and second ends, and first and second brush elements, one of which is on the first end of said thread element, and the other being on the second end of said thread element;
wherein each of said first and second brush elements comprises bristles or protrusions oriented substantially perpendicular to said thread element, each of said first and second brush elements having a conical or frustoconical portion having a smallest diameter closest to the thread element;
wherein said thread element has a length corresponding at least to the transverse dimension of a tooth or to the transverse dimension of a contact surface between said tooth and an adjacent tooth; and
wherein each of said first and second brush elements has a length at least corresponding to one half of said length of said thread element.

31. The dental interproximal cleaning element assembly according to claim 30, wherein said holder is integral with said cleaning element.

32. The dental interproximal cleaning element assembly according to claim 30, wherein said cleaning element includes two strands twisted around each other and bristles inserted between said strands along a portion of said strands to form said first and second brush elements, the remainder of said strands forming said thread element.

33. The dental interproximal cleaning element assembly according to claim 30, wherein said cleaning element includes a thread and a wire twisted around a portion of said thread to fix bristles to said thread to form said first and second brush elements, the remainder of said thread forming said thread element.

34. The dental interproximal cleaning element assembly according to claim 30, wherein said cleaning element includes a thread and bristles affixed to said thread along a portion of said thread to form said first and second brush elements, the remainder of said thread forming said thread element.

35. The dental interproximal cleaning element assembly according to claim 30, wherein said thread element includes a thread, and each of said first and second brush elements includes two wires twisted around each other to fix a plurality of bristles between said wires, said thread element having first and second ends, each of said first and second ends being joined to an end of one of said first and second brush elements.

36. The dental interproximal cleaning element assembly according to claim 30, wherein said cleaning element includes a thread having protrusions along a portion of said thread to form said first and second brush elements, the remainder of said thread forming said thread element.

37. The dental interproximal cleaning element assembly according to claim 36, wherein said cleaning element is moulded to include said protrusions.

38. The dental interproximal cleaning element assembly according to claim 36, wherein said protrusions are extruded from said thread.

39. The dental interproximal cleaning element assembly according to claim 30, wherein said cleaning element includes a thread having a moulded jacket along a portion of said thread to form said first and second brush elements, said jacket further having protrusions, and the remainder of said thread forming said thread element.

40. The dental interproximal cleaning element assembly according to claim 30, wherein one of said first and second brush elements has a first maximum diameter and the other of said first and second brush elements has a second maximum diameter smaller than said first maximum diameter.

41. The dental interproximal cleaning element assembly according to claim 30, wherein said cleaning element has a longitudinal dimension, and wherein each of said first and second brush elements has a diameter that varies along the longitudinal dimension of said cleaning element.
